(19) United States
(12) Patent Application Publication
(10) Pub. No.: US 2016/0125826 A1
(43) Pub. Date: May 5, 2016

(54) DISPLAY PANEL, PIXEL STRUCTURE THEREOF AND METHOD FOR DRIVING THE DISPLAY PANEL

(71) Applicant: SHENZHEN CHINA STAR OPTOELECTRONICS TECHNOLOGY CO., LTD., Shenzhen (CN)

(72) Inventors: Xiaohui YAO, Shenzhen (CN); Je Hao HSU, Shenzhen (CN)

(21) Appl. No.: 14/416,892

(22) PCT Filed: Oct. 15, 2014
(86) PCT No.: PCT/CN2014/088660

§ 371 Date: Jan. 15, 2016

(30) Foreign Application Priority Data
Sep. 18, 2014 (CN) 201410479934.8

(51) Int. Cl. G09G 3/36

(52) U.S. Cl. CPC G09G 3/3648; G09G 3/3688; G09G 2300/0452; G09G 2300/0426; G09G 2310/0251

(57) ABSTRACT

The present disclosure relates to a display panel, a pixel structure, and a method for driving the display panel. The pixel structure comprises a plurality of sub-pixels, each of which comprises: a main portion configured to receive a scan signal of a first scan line, and then to receive a data signal of a data line, so that it has a main-portion voltage; a first portion configured to receive the scan signal of the first scan line, and then to receive the data signal of the data line, so that it has a first-portion voltage; and a second portion configured to receive a scan signal of a second scan line, and then to receive the data signal of the data line, so that it a second-portion voltage, wherein the main-portion voltage, the first-portion voltage and the second-portion voltage are different from one another. The display panel can not only achieve lower color shift for 2D display, but also enable lower color shift for 3D display by using a voltage difference between the main portion and the first portion after turning the second portion into a light shielding area.

The present disclosure claims benefit of Chinese patent application CN 201410479934.8, entitled “DISPLAY PANEL, PIXEL STRUCTURES THEREOF AND METHOD FOR DRIVING THE DISPLAY PANEL” and filed on Sep. 18, 2014, which is incorporated herein by reference.

### TECHNICAL FIELD

The present disclosure relates to the image display technology. In particular, it relates to a display panel having both two-dimensional and three-dimensional display functions, a pixel structure thereof, and a method for driving the display panel.

### TECHNICAL BACKGROUND

With the development of display technology, three-dimensional display technology has become one of the most compelling technical trends so far. Film patterned retarder (FPR for short) is one of the mainstream three-dimensional display technologies. In FPR technology, a polarizing film is attached to a liquid crystal display panel and cooperates with polarizing glasses, so that a three-dimensional image is split into a left-eye image and a right-eye image, and then the images obtained are separately transmitted to the left eye and the right eye of a viewer, thereby enabling a three-dimensional display. However, there are certain defects in this technique, that is, crosstalk between the left eye image and the right eye image might occur when the viewer watches from a relatively large viewing angle. Crosstalk causes the images that the viewer is watching to be blurring.

In addition, a large size liquid crystal display panel using a vertical alignment display mode (VA mode for short) further presents a technical problem of color shift caused by the large viewing angle. In this regard, the manufacturers of the current liquid crystal display panels generally apply a charge-shared technology, in which a pixel electrode of each sub-pixel in a pixel structure is divided into two portions, respectively a main portion and a sub portion. Driven by the same grayscale voltage, different voltages are exerted on the main portion and sub portion, so as to control the liquid crystal molecules corresponding to the main and sub portions to deflect over different deflection angles, thereby realizing the effect of low color shift.

To avoid crosstalk during a three-dimensional display, the manufacturers of liquid crystal display panel would appropriately enlarge a shielding distance between the pixels located in adjacent lines when designing a three-dimensional FPR pixel structure, which, however, would deteriorate the transmittance under a two-dimensional display. Meanwhile, low color shift of such a liquid crystal display panel cannot be realized under three-dimensional display. Therefore, it is a technical issue that a person skilled in the related industry is committed to solve to equip the LCD panel with both two-dimensional and three-dimensional display functions while enabling an effect of low color shift.

### SUMMARY OF THE INVENTION

In order to solve the above problems, the present disclosure provides a display panel which has both two-dimension and three-dimension display functions and is further capable of a display effect of low color shift, a pixel structure thereof, and a method for driving the display panel.

The present disclosure provides a pixel structure comprising a plurality of sub-pixels, wherein a pixel electrode of each of the sub-pixels comprises:
a main portion configured to receive a scan signal of a first scan line, and then to receive a data signal of a data line, so that it has a main-portion voltage,
a first portion configured to receive the scan signal of the first scan line, and then to receive the data signal of the data line, so that it has a first-portion voltage, and
a second portion configured to receive a scan signal of a second scan line, and then to receive the data signal of the data line, so that it has a second-portion voltage,
wherein the main-portion voltage, the first-portion voltage, and the second-portion voltage are different from one another.

According to an embodiment of the present disclosure, the main portion is electrically connected to the data line through a first electrode and a second electrode of a main-portion charging switch, and a control terminal of the main-portion charging switch is electrically connected to the first scan line. Meanwhile, the main portion is further electrically connected. with a main-portion liquid crystal capacitor and a main-portion storage capacitor.

According to an embodiment of the present disclosure, the first portion is electrically connected to the data line through a first electrode and a second electrode of a first-portion charging switch, and a control terminal of the first-portion charging switch is electrically connected to the first scan line. Meanwhile, the first portion is further electrically connected with a first-portion liquid crystal capacitor and a first-portion storage capacitor, wherein both ends of either the first-portion liquid crystal capacitor or the first-portion storage capacitor are electrically connected to a first electrode and a second electrode of a first-portion discharge switch, and a control terminal of the first-portion discharge switch is electrically connected to the first scan line.

According to an embodiment of the present disclosure, the second portion is electrically connected to the data line through a first electrode and a second electrode of a second-portion charging switch, and a control terminal of the second-portion charging switch is electrically connected to the second scan line. The second portion is further electrically connected with a second-portion liquid crystal capacitor and a second-portion storage capacitor, wherein both ends of either the second-portion liquid crystal capacitor or the second-portion storage capacitor are electrically connected to a first electrode and a second electrode of a second-portion discharge switch, and a control terminal of the second-portion discharge switch is electrically connected to the second scan line.

According to an embodiment of the present disclosure, the main-portion liquid crystal capacitor, the first-portion liquid crystal capacitor, and the second-portion liquid crystal capacitor each are formed of common electrodes respectively between each of the main, first, and the second portions and a color filter substrate, and the main-portion storage capacitor, the first-portion storage capacitor, and the second-portion storage capacitor each are formed of common electrodes respectively between each of the main, first, and the second portions and an array substrate where they are located.

In addition, the present disclosure further provides a display panel, comprising:
a plurality of data lines,
a plurality of scan lines in a staggered arrangement with the data lines, forming a plurality of sub-pixel regions, and
a plurality of sub-pixels arranged inside the sub-pixel regions, wherein a pixel electrode of each of the sub-pixels comprises:
   a main portion configured to receive a scan signal of a first scan line, and then to receive a data signal of a data line, so that it has a main-portion voltage,
   a first portion configured to receive the scan signal of the first scan line, and then to receive the data signal of the data line, so that it has a first-portion voltage, and
   a second portion configured to receive a scan signal of a second scan line, and then to receive the data signal of the data line, so that it has a second-portion voltage,
   wherein the main-portion voltage, the first-portion voltage, and the second-portion voltage are different from one another.

According to an embodiment of the present disclosure, the main portion is electrically connected to the data line through a first electrode and a second electrode of a main-portion charging switch, and a control terminal of the main-portion charging switch is electrically connected to the first scan line. The main portion is further electrically connected with a main-portion liquid crystal capacitor and a main-portion storage capacitor.

The first portion is electrically connected to the data line through a first electrode and a second electrode of a first-portion charging switch, and a control terminal of the first-portion charging switch is electrically connected to the first scan line. The first portion is further electrically connected with a first-portion liquid crystal capacitor and a first-portion storage capacitor, wherein both ends of either the first-portion liquid crystal capacitor or the first-portion storage capacitor are electrically connected to a first electrode and a second electrode of a first-portion discharge switch, and a control terminal of the first-portion discharge switch is electrically connected to the first scan line.

The second portion is electrically connected to the data line through a first electrode and a second electrode of a second-portion charging switch, and a control terminal of the second-portion charging switch is electrically connected to the second scan line. The second portion is further electrically connected with a second-portion liquid crystal capacitor and a second-portion storage capacitor, wherein both ends of either the second-portion liquid crystal capacitor or the second-portion storage capacitor are electrically connected to a first electrode and a second electrode of a second-portion discharge switch, and a control terminal of the second-portion discharge switch is electrically connected to the second scan line.

Further, the main-portion liquid crystal capacitor, the first-portion liquid crystal capacitor, and the second-portion liquid crystal capacitor each are formed of common electrodes respectively between each of the main, first, and the second portions and a color filter substrate; and the main-portion storage capacitor, the first-portion storage capacitor, and a second-portion storage capacitor each are formed of common electrodes respectively between each of the main, first, and the second portions and an array substrate where they are located.

In addition, the present disclosure also provides a method for driving a display panel, wherein the display panel comprises a plurality of data lines, a plurality of scan lines, and a plurality of sub-pixels, the data lines and the scan lines are arranged in a staggered manner to form a plurality of sub-pixel regions, the sub-pixels are arranged inside the sub-pixel regions, and a pixel electrode in each of the sub-pixels comprises a main portion, a first portion, and a second portion,
said method comprises steps for driving a two-dimensional display and/or a three-dimensional display:
the steps for driving the two-dimensional display include: during a positive/negative polarity reversal period,
   transmitting, at a same time point, a data signal respectively to the main portion and the first portion through a data line, so that the main portion and the first portion respectively have a main-portion voltage and a first-portion voltage, and
   transmitting, at a next time point, a data signal to the second portion through the data line, so that the second portion has a second-portion voltage,
   wherein the main-portion voltage, the first-portion voltage, and the second-portion voltage are different from one another;
the steps for driving the three-dimensional display include:
   turning the second portion into a black area and maintaining its dark state, and
   transmitting, at a same time point, a data signal respectively to the main portion and the first portion through the data line, so that the main portion and the first portion respectively have a main-portion voltage and a first-portion voltage, wherein there is a predetermined voltage difference between the main-portion voltage and the first-portion voltage.

Further, in the steps for driving the three-dimensional display, it is preferable to carry out black frame insertion during a vertical retrace period, so as to turn the second portion into a black area.

As compared with the prior art, one or more embodiments of the present disclosure can have the following advantages.

The display panel of the present disclosure comprises a pixel structure comprising a 1D2G structure (comprising one data line and two scan lines), three portions (a portion Main, a portion Sub1 and a portion Sub2) and twelve domains, which can not only achieve a lower color shift under the two-dimensional display mode by differing the voltages in said three portions from one another, but also enable a lower color shift under the three-dimensional display mode by applying a voltage difference between the portions Main and Sub1. after forming a wider light shielding area needed for the three-dimensional display in the portion Sub2. In this case, on the premise of guaranteeing the transmittance under the two-dimensional display, a compatibility of two-dimensional display and three-dimensional display is achieved, and better effect of low color shift is further realized in both the two-dimensional display and the three-dimensional display, thereby improving the image display quality.

Other features and advantages of the present disclosure will be further explained in the following description and partially become apparent therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE ACCOMPANYING DRAWINGS

The accompanying drawings, which constitute a part of the description, are used to further explain the present disclosure in view of the embodiments. It should be understood that the drawings are only provided to better understand the present disclosure, they should not be construed as limitations thereto. In the accompanying drawings:

FIG. 1 schematically shows a structure of a display panel according to Example 1 of the present disclosure;

FIG. 2 schematically shows a structure of a pixel electrode in a sub-pixel according to Example 1 of the present disclosure;

FIG. 3 shows an equivalent circuit of the sub-pixel of FIG. 2; and

FIG. 4 schematically shows the operating condition of the pixel electrode in the sub-pixel of FIG. 2 under a three-dimensional display mode.

### DETAILED DESCRIPTION OF THE EMBODIMENTS

To clarify the objectives, technical solutions, and the advantages of the present disclosure, the present disclosure will be further described in details with reference to the following specific embodiments and the accompanying drawings.

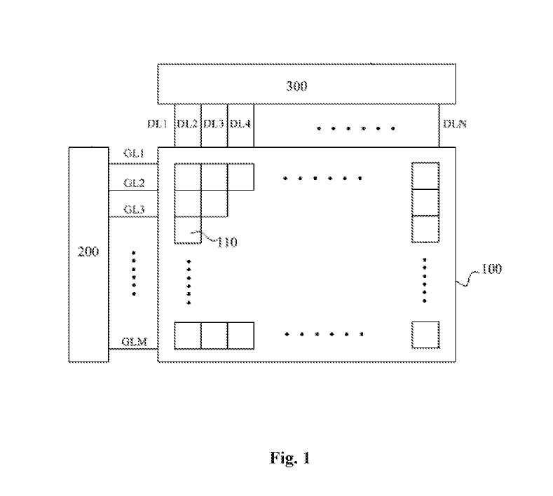

FIG. 1 schematically shows a structure of a display panel according to Example 1 of the present disclosure. The display panel comprises an image display area 100, a scan driving circuit 200 and a data driving circuit 300. The image display area 100 comprises an array formed by a plurality of scan lines GL1 to GLM and a plurality of data lines DL1 to DLN in a staggered arrangement, as well as a plurality of pixel structures 110 serving as elements of the array. In this case, the scan driving circuit 200 transmits scan signals to the pixel structures 110 in the image display area 100 through a plurality of scan lines GL1 to GLM coupled to the scan driving circuit 200. The data driving circuit 300 transmits data signals to the pixel structures 110 in the image display area 100 through a plurality of data lines DL1 to DLN coupled to the data driving circuit 300.

Generally, each of the pixel structures 110 of a color display panel contains a red sub-pixel, a green sub-pixel, and a blue sub-pixel. In Example 1, all of the sub-pixels use a 1D2G structure. That is, for one sub-pixel, a sub-pixel region (i.e., a pixel electrode region defining the sub-pixel) is defined by a longitudinal data line together with a horizontal first scan line and a horizontal second scan line.

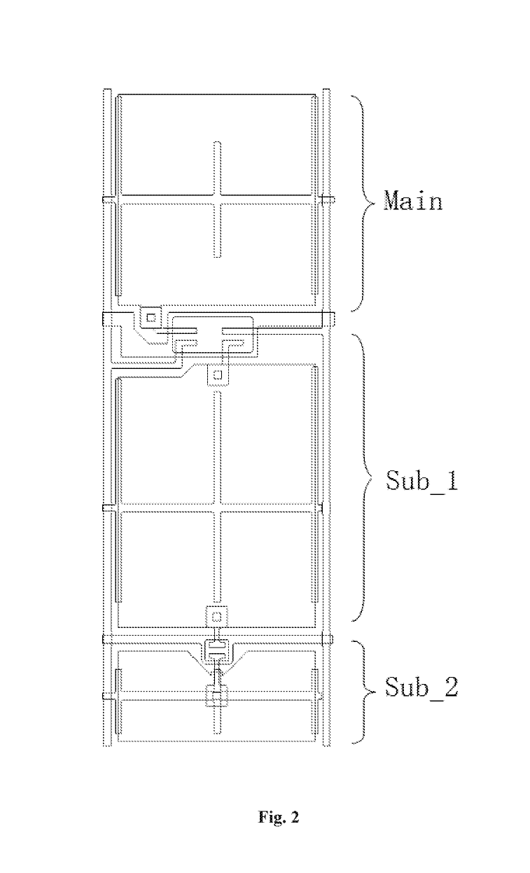

FIG. 2 schematically shows a structure of a pixel electrode in the sub-pixel according to Example 1 of the present disclosure. The pixel electrode is divided into three portions, i.e., a main portion Main, a first portion Sub 1 and a second portion Sub2, wherein preferably, each of the portions is divided into four domains.

The main portion Main is configured to receive a scan signal Gn of the first scan line and then to receive a data signal Data of the data line under the action of the scan signal Gn, so that it has a main-portion voltage V_Main.

The first portion Sub1 is configured to receive the scan signal Gn of the first scan line, and then to receive a data signal Data of the data line under the action of the scan signal Gn, so that it has a first-portion voltage V_Sub1.

The second portion Sub2 is configured to receive a scan signal Gn+1 of the second scan line, and then to receive a data signal Data of the data line under the action of the scan signal Gn+1, so that it has a second-portion voltage V_Sub2.

In this case, the main-portion voltage V_Main, the first-portion voltage V_Sub1, and the second-portion voltage V_Sub2 should be different from one another, so that low color shift of the LCD panel under a two-dimensional display mode can be realized. Furthermore, when the LCD panel operates under a three-dimensional display mode, the second portion Sub2 disenables its display function and serves as a light shielding area. Meanwhile, since the main-portion voltage V_Main is different from the first-portion voltage V_Sub1, the effect of low color shift can also be realized.

It should be noted that, in this example, the first scan line Gn and the second scan line Gn+1 can be arranged as two adjacent scan lines, which, however, may not be limited hereto in practical applications.

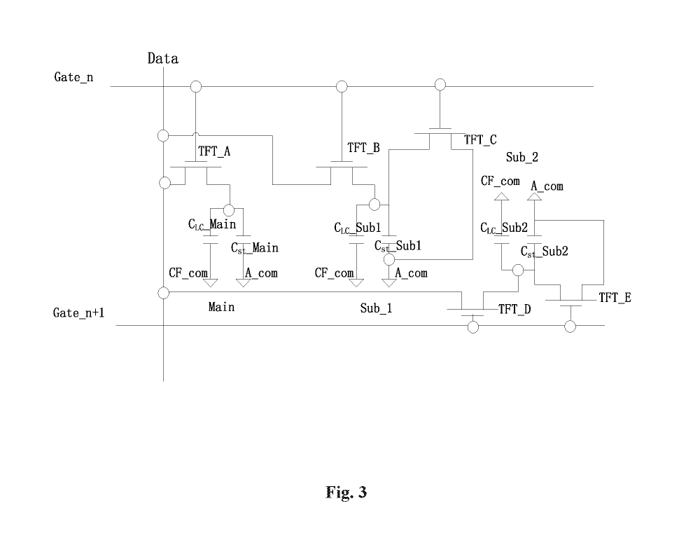

FIG. 3 shows an equivalent circuit of the sub-pixel shown in FIG. 2.

For the main portion Main, a main-portion charging switch TFT_A electrically connects the data line to the main portion with its first electrode and second electrode, and a control terminal of the charging switch TFT_A is electrically connected to a first scan line to receive a scan signal Gn. Meanwhile, the main portion Main is further electrically connected to a storage capacitor Cst_Main and a liquid crystal capacitor Clc_Main. Under the action of the scan signal Gn, the charging switch TFT_A is enabled, and a data signal Data of the data line is transmitted to the storage capacitor Cst_Main and the liquid crystal capacitor Clc_Main via the charging switch TFT_A. The storage capacitor Cst_Main and the liquid crystal capacitor Clc_Main each are charged based on the data signal Data, and then store the corresponding potentials. As a result, the main portion Main has a corresponding main-portion voltage V_Main, so that the liquid crystal moleculars corresponding to the main portion Main deflect accordingly, thereby displaying the corresponding image data.

In a specific example, the storage capacitor Cst_Main of the main portion can be formed of a common electrode A_com between the main portion Main and an array substrate where the main portion is positioned, and the liquid crystal capacitor Clc_Main in the main portion may be formed of a common electrode CF_com between the main portion and a color filter substrate.

For the first portion Sub1, a first-portion charging switch TFT_B electrically connects the data line to the first portion Sub1 with its first and second electrodes, and a control terminal of the charging switch TFT_B is electrically connected to the first scan line to receive the scan signal Gn. Meanwhile, the first portion Sub1 is also electrically connected to a storage capacitor Cst_Sub1 and a liquid crystal capacitor Clc_Sub1, wherein both ends of either the storage capacitor Cst_Sub1 or the liquid crystal capacitor Clc_Sub1 are electrically connected to a first electrode and a second electrode of a discharge switch TFT_C, and a control terminal of the discharge switch TFT_C is electrically connected to the first scan line to receive the scan signal Gn. Under the action of the scan signal Gn, the charging switch TFT_B is enabled, then the data signal Data of the data line is transmitted to the storage capacitor Cst_Sub1 and the liquid crystal capacitor Clc_Sub 1 via the charging switch TFT_B. Then the storage capacitor Cst_Sub1 and the liquid crystal capacitor Clc_Sub1 each are charged based on the data signal Data and then store the corresponding potentials. In the meantime, since the discharge switch TFT_C is also enabled, the potentials of the storage capacitor Cst_Sub1 and the liquid crystal capacitor Clc_Sub1 decline due to the electric leakage through the discharge switch TFT_C. In this case, the first portion Sub1 has a first-portion voltage V_Sub1, a level of which is different from that of the main-portion voltage V_Main, so that the liquid crystal moleculars corresponding to the first portion Sub1 deflect accordingly, thereby displaying the corresponding image data.

In a specific example, the storage capacitor Cst_Sub1 of the first portion may be formed of a common electrode A_com between the first portion Sub1 and an array substrate where the first portion is positioned, and the liquid crystal capacitor Clc_Sub1 of the first portion may be formed of a common electrode CF_com between the first portion Sub1 and a color filter substrate.

For the second portion Sub2, a second-portion charging switch TFT_D electrically connects the data line to the second portion Sub2 with its first and second electrodes, and a control terminal of the charging switch TFT_D is electrically connected to a second scan line to receive a scan signal Gn+1. Meanwhile, the second portion Sub2 is also electrically connected to a storage capacitor Cst_Sub2 and a liquid crystal capacitor Clc_Sub2, wherein both ends of either the storage capacitor Cst_Sub2 or the liquid crystal capacitor Clc_Sub2 are electrically connected to a first electrode and a second electrode of a discharge switch TFT_E, and a control terminal of the discharge switch TFT_E is electrically connected to the second scan line to receive the scan signal Gn+1. Under the action of the scan signal Gn+1, the charging switch TFT_D is enabled, the data signal Data of the data line is transmitted to the storage capacitor Cst_Sub2 and the liquid crystal capacitor Clc_Sub2 via the charging switch TFT_D. The storage capacitor Cst_Sub2 and the liquid crystal capacitor Clc_Sub2 each are charged based on the data signal Data, and then store the corresponding potentials. In the meantime, since the discharge switch TFT_E is also enabled, the potentials of the storage capacity Cst_Sub2 and the liquid crystal capacitor Clc_Sub2 decrease due to the electric leakage through the discharge switch TFT_E. As a result, the second portion has a second-portion voltage V_Sub2, a level of which is different from that of the main-portion voltage V_Main, so that the liquid crystal corresponding to the second portion Sub2 deflects accordingly, thereby displaying the corresponding image data.

In a specific example, the storage capacitor Cst_Sub2 of the second portion can be formed of a common electrode A_com between the second portion Sub2 and an array substrate where the second portion is located, and the liquid crystal capacitor Clc_Sub2 of the second portion can be formed of a common electrode CF_com between the second portion Sub2 and a color filter substrate.

It should be noted that each of the potentials V_Main, V_Sub1, and V_Sub2 of the pixel electrodes of the sub-pixels as mentioned above or will be mentioned below can refer to a voltage of a pixel electrode per se, or to a voltage difference between the pixel electrode and the common electrode A_com of the array substrate or that between the pixel electrode and the common electrode CF_com of the color filter substrate, which is generally known in the art. Accordingly, the meaning of the potential of a pixel electrode in the present disclosure is not limited to that as defined by the examples of the present disclosure.

Said charging switches and discharge switches are preferably made of thin film transistors. A first electrode and a second electrode of each of the charging switches and the discharge switches are usually the drain electrode and the source electrode, and a control terminal thereof is the gate electrode.

Detailed description of the circuit operating condition and the voltage changes in each of the portions of a pixel electrode respectively under a two-dimensional display mode and a three-dimensional display mode will be given below.

During a positive polarity inversion period under a two-dimensional display mode, a voltage of the data signal is higher than that of the common electrode which refers to the common electrode CF_com of the color filter substrate and/or the common electrode A_com of the array substrate in this example.

1) In the case that a scan signal Gn of the first scan line is of high level while a scan signal Gn+1 of the second scan line is of low level.

The charging switch TFT_A in the main portion is enabled, so that a data signal Data of the data line is transmitted to the liquid crystal capacitor Clc_Main and the storage capacitor Cst_Main in the main portion via the charging switch TFT_A. The liquid crystal capacitor Clc_Main and the storage capacitor Cst_Main in the main portion are charged based on the data signal Data, and store the corresponding voltages, i.e., a main-portion voltage V_Main.

The charging switch TFT_B and the discharge switch TFT_C in the first portion are turned on, so that data signal Data of the data line is transmitted to the liquid crystal capacitor Clc_Sub1 and the storage capacitor Cst_Sub1 in the first portion via the charging switch TFT_B. Then the liquid crystal capacitor Clc_Sub1 and the storage capacitor Cst_Sub1 in the first portion are charged based on the data signal Data and store the corresponding voltages. At the same time, because the discharge switch TFT_C is also turned on, the potentials of the liquid crystal capacitor Clc_Sub1 and the storage capacitor Cst_Sub1 in the first portion decline to a first-portion voltage V_Sub1, a level of which is different from that of the main-portion voltage V_Main, due to the electric leakage from the discharge switch TFT_C.

The charging switch TFT_D and the discharge switch TFT_E in the second portion are both turned off and thus the second-portion voltage V_Sub2 is zero.

2) In the case that the scan signal Gn of the first scan line is of low level while the scan signal Gn+1 of the second scan line is of high level.

The charging switch TFT_A in the main portion, and the charging switch TFT_B and the discharge switch TFT_C in the first portion are turned off, and thus the main-portion voltage V_Main and the first-portion voltage V_Sub1 both remain the same.

The charging switch TFT_D and the discharge switch TFT_E in the second portion are both enabled, so that the data signal Data of the data line is transmitted to the liquid crystal capacitor Clc_Sub2 and the storage capacitor Cst_Sub2 in the second portion via the charging switch TFT_D. Then, the liquid crystal capacitor Clc_Sub2 and the storage capacitor Cst_Sub2 in the second portion are charged based on the data signal Data and store the corresponding voltages. In the meantime, since the discharge switch TFT_E is enabled, the potentials of the liquid crystal capacitor Clc_Sub2 and the storage capacitor Cst_Sub2 in the second portion may decline to a second-portion voltage V_Sub2, a level of which is different from that of the main-portion voltage V_Main, due to the electric leakage through the discharge switch TFT_E.

During a negative polarity inversion period under a two-dimensional display mode, a voltage of the data signal is lower than that of the common electrode which refers to the common electrode common CF_com of the color filter substrate and/or the common electrode A_com of the array substrate in this example.

1) In the case that a scan signal Gn of the first scan line is of high level while a scan signal Gn+1 of the second scan line is of low level.

The charging switch TFT_A in the main-portion is turned on, so that a data signal Data is transmitted to the liquid crystal capacitor Clc_Main and the storage capacitor Cst_Main in the main portion via the charging switch TFT_A. Then, the liquid crystal capacitor Clc_Main and the storage capacitor Cst_Main in the main portion discharge based on the data signal Data and store the corresponding voltages, i.e., a main-portion voltage V_Main.

The charging switch TFT_B and the discharge switch TFT_C in the first portion are both enabled, so that the data signal Data of the data line is transmitted to the liquid crystal capacitor Clc_Sub1 and the storage capacitor Cst_Sub1 in the first portion via the charging switch TFT_B. Then, the liquid crystal capacitor Clc_Sub1 and the storage capacitor Cst_Sub1 in the first portion discharge based on the data signal Data and store the corresponding voltages. At the same time, since the discharge switch TFT_C is also turned on, the potentials of the liquid crystal capacitor Clc_Sub1 and the storage capacitor Cst_Sub1 in the first portion increase to a first-portion voltage V_Sub1, a level of which is different from that of the main-portion voltage V_Main, due to the electric leakage from the discharge switch TFT_C.

The charging switch TFT_D and the discharge switch TFT_E in the second portion are both disenabled, and thus the second-portion voltage V_Sub2 is zero.

2) In the case that the scan signal Gn of the first scan line is of low level while the scan signal Gn+1 of the second scan line is of high level.

The charging switch TFT_A in the main portion, and the charging switch TFT_B and the discharge switch TFT_C in the first portion are disenabled, and thus the main-portion voltage V_Main and the first-portion voltage V_Sub1 both remain the same.

The charging switch TFT_D and the discharge switch TFT_E in the second portion are enabled, so that the data signal Data of the data line is transmitted to the liquid crystal capacitor Clc_Sub2 and the storage capacitor Cst_Sub2 in the second portion via the charging switch TFT_D. Then, the liquid crystal capacitor Clc_Sub2 and the storage capacitor Cst_Sub2 in the second portion discharge based on the data signal Data and store the corresponding voltages. In the meantime, since the discharge switch TFT_E is enabled, the potentials of the liquid crystal capacitor Clc_Sub2 and the storage capacitor Cst_Sub2 in the second portion increase to a second-portion voltage V_Sub2, a level of which is different from that of the main-portion voltage V_Main, due to the electric leakage from the discharge switch TFT_E.

In a specific example, when the voltage difference between the main-portion voltage V_Main and the first-portion voltage V_Sub 1 differs from that between the main-portion voltage V_Main and the second-portion voltage V_Sub2, the requirement that the main-portion voltage V_Main, the first-portion voltage V_Sub1 and the second-portion voltage V_Sub2 should be different from one another is naturally met.

In this case, whether it is during the positive polarity inversion period or the negative polarity inversion period, the main-portion voltage, the first-portion voltage and the second-portion voltage in the pixel electrode are different from one another, As a result, images displayed by these three portions are significantly different from one another, thereby achieving a low color shift display under the two-dimensional display mode.

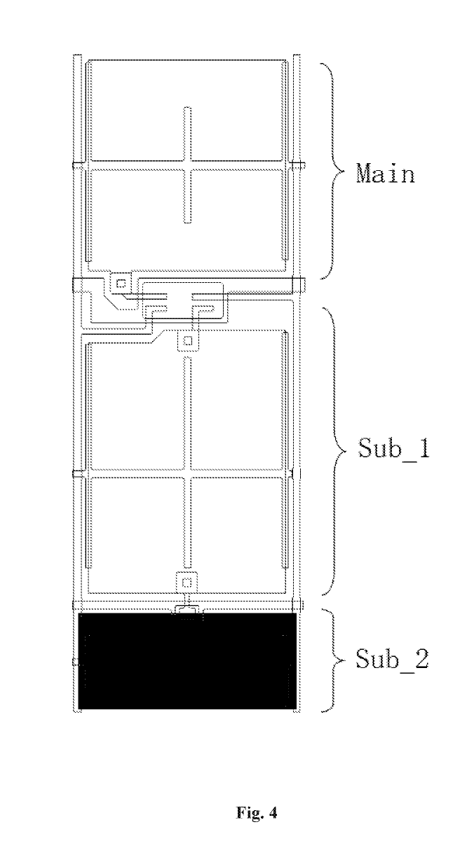

FIG. 4 schematically shows the operating condition of the pixel electrode in the sub-pixel of FIG. 2 under a three-dimensional display mode. In order to achieve low color shift display under the three-dimensional display mode, the second portion in the pixel electrode is configured to be a light shielding area required for three-dimensional display, so that a sufficient shielding distance between two adjacent lines of a pixel structure can be guaranteed, and also a significant voltage difference between the main portion and the first portion can be obtained. In this example, it is preferred to perform black frame insertion to the second portion during the vertical retrace, so that the second portion becomes a black area. Then, the scan signal Gn+1 controlling the operation of the second portion is disenabled so that the second-portion voltage V_Sub2 is zero, thereby keeping the second portion in a dark state to avoid light leakage caused by electric leakage. Similar to that in the two-dimensional display mode, the data signal is transmitted simultaneously to the main portion and the first portion via the data line, and thus the main portion and the first portion. each have a main-portion voltage and a first-portion voltage, and between the two voltages there is a predetermined voltage difference. Due to the voltage difference between the main portion voltage and the first-portion voltage, images displayed by the main portion and the first portion are significantly different, thereby effectively solve the problem of color shift during the three-dimensional display.

The above are only preferred embodiments of the present disclosure, and the scope of the present invention is not limited thereto. Any changes or replacement within the technical scope of the present disclosure which easily occur to a person skilled in the art should fall within the scope of the present disclosure. Accordingly, the scope of the invention should be subjected to that defined in the claims.

1. A pixel structure comprising a plurality of sub-pixels, wherein a pixel electrode of each of the sub-pixels comprises:
a main portion, configured to receive a scan signal of a first scan line and then to receive a data signal of a data line, so that it has a main-portion voltage,
a first portion, configured to receive the scan signal of the first scan line and then to receive the data signal of the data line, so that it has a first-portion voltage, and
a second portion, configured to receive a scan signal of a second scan line and then to receive the data signal of the data line, so that it has a second-portion voltage,
wherein the main-portion voltage, the first-portion voltage, and the second-portion voltage are different from one another.

2. The pixel structure according to claim 1, wherein
the main portion is electrically connected to the data line through a first electrode and a second electrode of a main-portion charging switch, and a control terminal of the main-portion charging switch is electrically connected to the first scan line, and
the main portion is further electrically connected with a main-portion liquid crystal capacitor and a main-portion storage capacitor.

3. The pixel structure according to claim 1, wherein
the first portion is electrically connected to the data line through a first electrode and a second electrode of a first-portion charging switch, and a control terminal of the first-portion charging switch is electrically connected to the first scan line, and
the first portion is further electrically connected with a first-portion liquid crystal capacitor and a first-portion storage capacitor, wherein both ends of either the first-portion liquid crystal capacitor or the first-portion storage capacitor are electrically connected to a first electrode and a second electrode of a first-portion discharge switch, and a control terminal of the first-portion discharge switch is electrically connected to the first scan line.

4. The pixel structure according to claim 2, wherein
the first portion is electrically connected to the data line through a first electrode and a second electrode of a first-portion charging switch, and a control terminal of the first-portion charging switch is electrically connected to the first scan line, and
the first portion is further electrically connected with a first-portion liquid crystal capacitor and a first-portion storage capacitor, wherein both ends of either the first-portion liquid crystal capacitor or the first-portion storage capacitor are electrically connected to a first electrode and a second electrode of a first-portion discharge switch, and a control terminal of the first-portion discharge switch is electrically connected to the first scan line.

5. The pixel structure according to claim 1, wherein
the second portion is electrically connected to the data line through a first electrode and a second electrode of a second-portion charging switch, and a control terminal of the second-portion charging switch is electrically connected to the second scan line, and
the second portion is further electrically connected with a second-portion liquid crystal capacitor and a second-portion storage capacitor, wherein both ends of either the second-portion liquid crystal capacitor or the second-portion storage capacitor are electrically connected to a first electrode and a second electrode of a second-portion discharge switch, and a control terminal of the second-portion discharge switch is electrically connected to the second scan line.

6. The pixel structure according to claim 2, wherein
the second portion is electrically connected to the data line through a first electrode and a second electrode of a second-portion charging switch, and a control terminal of the second-portion charging switch is electrically connected to the second scan line, and
the second portion is further electrically connected with a second-portion liquid crystal capacitor and a second-portion storage capacitor, wherein both ends of either the second-portion liquid crystal capacitor or the second-portion storage capacitor are electrically connected to a first electrode and a second electrode of a second-portion discharge switch, and a control terminal of the second-portion discharge switch is electrically connected to the second scan line.

7. The pixel structure according to claim 3, wherein
the second portion is electrically connected to the data line through a first electrode and a second electrode of a second-portion charging switch, and a control terminal of the second-portion charging switch is electrically connected to the second scan line, and
the second portion is further electrically connected with a second-portion liquid crystal capacitor and a second-portion storage capacitor, wherein both ends of either the second-portion liquid crystal capacitor or the second-portion storage capacitor are electrically connected to a first electrode and a second electrode of a second-portion discharge switch, and a control terminal of the second-portion discharge switch is electrically connected to the second scan line.

8. The pixel structure according to claim 4, wherein
the second portion is electrically connected to the data line through a first electrode and a second electrode of a second-portion charging switch, and a control terminal of the second-portion charging switch is electrically connected to the second scan line, and
the second portion is further electrically connected with a second-portion liquid crystal capacitor and a second-portion storage capacitor, wherein both ends of either the second-portion liquid crystal capacitor or the second-portion storage capacitor are electrically connected to a first electrode and a second electrode of a second-portion discharge switch, and a control terminal of the second-portion discharge switch is electrically connected to the second scan line.

9. The pixel structure according to claim 8, wherein
the main-portion liquid crystal capacitor, the first-portion liquid crystal capacitor, and the second-portion liquid crystal capacitor each are formed of common electrodes respectively between each of the main, first, and the second portions and a color filter substrate, and
the main-portion storage capacitor, the first-portion storage capacitor, and the second-portion storage capacitor each are formed of common electrodes respectively between each of the main, first, and the second portions and an array substrate where each of them is located.

10. A display panel, comprising:
a plurality of data lines,
a plurality of scan lines in a staggered arrangement with the data lines, forming a plurality of sub-pixel regions, and
a plurality of sub-pixels disposed inside the sub-pixel regions, wherein a pixel electrode of each of the sub-pixels comprises:
a main portion configured to receive a scan signal of a first scan line, and then to receive a data signal of a data line, so that it has a main-portion voltage,
a first portion configured to receive the scan signal of the first scan line, and then to receive the data signal of the data line, so that it has a first-portion voltage, and
a second portion configured to receive a scan signal of a second scan line, and then to receive the data signal of the data line, so that it has a second-portion voltage,
wherein the main-portion voltage, the first-portion voltage, and the second-portion voltage are different from one another.

11. The display panel according to claim 10, wherein in the pixel electrode of each of the sub-pixels:
the main portion is electrically connected to the data line through a first electrode and a second electrode of a main-portion charging switch, and a control terminal of the main-portion charging switch is electrically connected to the first scan line; and the main portion is further electrically connected with a main-portion liquid crystal capacitor and a main-portion storage capacitor,
the first portion is electrically connected to the data line through a first electrode and a second electrode of a first-portion charging switch, and a control terminal of the first-portion charging switch is electrically connected to the first scan line; and the first portion is further electrically connected with a first-portion liquid crystal capacitor and a first-portion storage capacitor, wherein both ends of either the first-portion liquid crystal capacitor or the first-portion storage capacitor are electrically connected to a first electrode and a second electrode of a first-portion discharge switch, and a control terminal of the first-portion discharge switch is electrically connected to the first scan line, and
the second portion is electrically connected to the data line through a first electrode and a second electrode of a second-portion charging switch, and a control terminal of the second-portion charging switch is electrically connected to the second scan line; and the second portion is further electrically connected with a second-portion liquid crystal capacitor and a second-portion storage capacitor, wherein both ends of either the second-portion liquid crystal capacitor or the second-portion storage capacitor are electrically connected to a first electrode and a second electrode of a second-portion discharge switch, and a control terminal of the second-portion discharge switch is electrically connected to the second scan line.

12. The display panel according to claim 11, wherein the main-portion liquid crystal capacitor, the first-portion liquid crystal capacitor, and the second-portion liquid crystal capacitor each are formed of common electrodes respectively between each of the main, first, and the second portions and a color filter substrate, and
the main-portion storage capacitor, the first-portion storage capacitor and a second-portion storage capacitor each are formed of common electrodes respectively between each of the main, first, and the second portions and an array substrate where each of them is located.

13. A method for driving a display panel, the display panel comprising a plurality of data lines, a plurality of scan lines, and a plurality of sub-pixels, wherein the data lines and the scan lines are arranged in a staggered manner to form a plurality of sub-pixel regions, the sub-pixels are disposed inside the sub-pixel regions, and a pixel electrode in each of the sub-pixels comprises a main portion, a first portion, and a second portion,
said method comprising steps for driving two-dimensional display and/or three-dimensional display, wherein
the steps for driving the two-dimensional display include, during a positive/negative polarity reversal period:
transmitting, at one single time point, a data signal respectively to the main portion and the first portion through a data line, so that the main portion and the first portion respectively have a main-portion voltage and a first-portion voltage, and
transmitting, at a next time point, a data signal to the second portion through the data line, so that the second portion has a second-portion voltage,
wherein the main-portion voltage, the first-portion voltage and the second-portion voltage are different from one another;
the steps for driving the three-dimensional display include:
turning the second portion into a black area and maintaining its dark state, and
transmitting, at one single time point, a data signal respectively to the main portion and the first portion through the data line, so that the main portion and the first portion respectively have a main-portion voltage and a first-portion voltage, a predetermined voltage difference existing between the main-portion voltage and the first-portion voltage.

14. A method according to claim 13, wherein in the steps for driving the three-dimensional display, black frame insertion is performed during vertical retrace so that the second portion can form a black area.
